(19) United States
(12) Patent Application Publication
(10) Pub. No.: US 2026/0119558 A1
(43) Pub. Date: Apr. 30, 2026

(54) Selecting Attributes to Display for a Set of Search Results

(71) Applicant: Oracle International Corporation, Redwood Shores, CA (US)

(72) Inventors: Jennifer Darmour, Seattle, WA (US); Hillel Noah Cooperman, Seattle, WA (US)

(73) Assignee: Oracle International Corporation, Redwood Shores, CA (US)

(21) Appl. No.: 19/370,129

(22) Filed: Oct. 27, 2025

Related U.S. Application Data
(60) Provisional application No. 63/712,928, filed on Oct. 28, 2024.

(51) Int. Cl. G06F 16/335; G06F 16/334; G06F 16/38

(52) U.S. Cl. CPC G06F 16/335; G06F 16/334; G06F 16/38

(57) ABSTRACT

Techniques for presenting a set of machine-learning predicted database record attributes for displaying in response to a request to filter a set of query results are disclosed. In response to a query, a system returns a set of system results. Based on receiving a selection of a query filter, the system presents a set of filtered query results. For a record in the set of filtered query results, the system presents a value for at least one default attribute and a value for at least one machine-learning predicted attribute. The system supplements the default attributes by applying a machine learning model to a set of filter data. The machine learning model generates a set of predicted attributes to present together with the default attributes for the set of query results.

### BENEFIT CLAIMS; RELATED APPLICATIONS; INCORPORATION BY REFERENCE

This application claims the benefit of U.S. Provisional Patent Application 63/712,928, filed Oct. 28, 2024, which is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to displaying query results with system-selected attributes for each of the query results.

### BACKGROUND

Databases store vast quantities of data that are accessed and modified by different types of applications. Applications present user interfaces that allow users to initiate queries to the databases and view query results. Applying filters to query results allows users to focus in on a set of database records that the users consider the most relevant.

A database record may include a large set of attributes and corresponding attribute values. Query terms and filters narrow down a number of attribute values presented to a user. However, without knowing attributes associated with a database record, a user may spend time applying additional filters and entering additional query terms until the user arrives at the information they seek. Each additional search consumes computing resources, including processing capacity, bandwidth, and database server access.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1A illustrates a system in accordance with one or more embodiments;

FIG. 1B illustrates a machine learning (ML) engine in accordance with one or more embodiments;

FIG. 2 illustrates a set of operations of a machine learning engine in accordance with one or more embodiments;

FIG. 3 illustrates an example set of operations for determining attributes to display for a set of search results in accordance with one or more embodiments;

FIGS. 4A-4C illustrate an example embodiment; and

FIG. 5 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. REAL-TIME QUERY RESULTS ATTRIBUTE DETERMINATION ARCHITECTURE
3. MACHINE LEARNING ARCHITECTURE
4. GENERATIVE MODELS
5. SELECTING ATTRIBUTES TO DISPLAY FOR A SET OF SEARCH RESULTS
6. EXAMPLE EMBODIMENT
7. PRACTICAL APPLICATIONS, ADVANTAGES, AND IMPROVEMENTS
8. COMPUTER NETWORKS AND CLOUD NETWORKS
9. HARDWARE OVERVIEW
10. MISCELLANEOUS; EXTENSIONS

### 1. General Overview

A database search may identify a set of query results that include a target set of records. The target set of records may be determined in response to a query and/or in response to filters that are applied for further filtering of records after an initial set of records are displayed. Each record, of the target set of records, is associated with a set of attributes. Each attribute for a record has a corresponding value stored in a respective field of the record.

One or more embodiments improve the searchability of a visualized set of query results by selecting, in real time, attributes for displaying in the query results based on query information. Instead of displaying all the attribute values for a record or a preselected set of attribute values in accordance with a static configuration, the system selects the attributes to display for each record based on the query. One or more embodiments improve the execution of queries and the transmission of query results to a requesting client computer by extracting attribute values not specified by query terms and predicted to be relevant to the query results. Presenting attribute values for attributes not specified by the query terms and relevant to the query improves the query execution process by providing query results with fewer interactions between a client and a database server, improving bandwidth and processing capacity availability. Predicting and retrieving relevant attributes not specified in a query prior to transmitting query results to a client enables increased query execution efficiency by allowing a database server to store an initial set of query results in short-term memory or cache memory while executing additional queries to obtain relevant attribute values.

One or more embodiments select the attributes to present in a query response based on a target set of records included in the query results. Additionally, or alternatively, the system may select the attributes based on a set of filters applied to filter the initial set of records to generate the target set of records. Accordingly, the system may determine the attributes to display for the records in the query results after receiving the query for execution and/or after determining the results for the query.

In an example, if the query results include different types of sports cars, the system may display the horsepower for each sports car in addition to identifying the sports cars in the query results. The system selects horsepower for display because the system determines there is a high likelihood that a user searching for sports cars wants to know the horsepower for each sports car. The system may refrain from displaying the maximum seating for each sports car even though the maximum seating information is available for each sports car. If the query results include different types of minivans, the system may display maximum seating for each minivan in addition to identifying the minivans in the query results. The system selects maximum seating for display because the system determines there is a high likelihood that a user searching for minivans wants to know the maximum seating for each minivan. In this case, the system may refrain from displaying the horsepower for each minivan even though the horsepower information is available for each minivan.

The system may display different attributes based on a time of day, day of week, week of month/year, month of year, etc. As an example, if a query for medication is executed in the morning, the system may display information indicating whether each medication, in the search results, is drowsy or non-drowsy. If a query for medication is executed in the night, the system may not display the information indicating whether each medication, in the search results, is drowsy or non-drowsy.

One or more embodiments display different attributes for different records in a set of search results. The system may partition a set of records in a set of search results based on the attributes selected by the system for displaying with each respective record. In an example, a user executes a query for restaurants near a particular address. The system determines search results that include both restaurants that are “walkable” and restaurants that are not “walkable.” Walkable restaurants may include restaurants within a certain distance from the particular address and/or restaurants connected to the particular address by sidewalks. The system selects an elevation change (between the particular address and a restaurant) as an attribute for displaying for each walkable restaurant since a user may walk to the restaurant, and elevation change is an important consideration when walking to a restaurant. The system may refrain from selecting an elevation change as an attribute for displaying for each non-walkable restaurant since an elevation change is not an important consideration when driving to a restaurant. Furthermore, based on the different selected attributes, the system displays a first section with walkable restaurants and the corresponding selected attributes. The system displays a separate, second section with non-walkable restaurants and the corresponding selected attributes.

One or more embodiments apply a machine learning (ML) model to determine the set of attributes to display for each record in a set of query results. A system may present at least one default attribute, such as a record name, for the records in the set of query results. The system supplements default attributes by applying a machine learning model to a set of filter data. The machine learning model generates a set of predicted attributes to present together with the default attributes for the set of query results. The machine learning model may be trained to predict attributes based on a relevance of the attributes to the query. For example, a user may access a medical information homepage. The homepage lists various medical information, including doctor visits, medications prescribed, and test results received. The system presents the medical information for a particular user based on executing a database query to a database storing tables, objects, or hierarchical nodes with the user's medical information. The user may select an icon in a user interface to filter the medical information to focus on medications. The filtered data set lists medications prescribed and omits other record types, including “doctor visits” and “lab results.” The system presents filter data, including the filter identifier, “medications,” and user data, “Jane Doe,” to a machine learning model. The machine learning model is trained to identify additional attributes to present to a user together with a set of default system-defined attributes. Based on the “medications” record type and the user data, the machine learning model may generate a prediction specifying different attributes, including the following: “Status” data, specifying if the user is currently taking the medication; “Cost” data, specifying a cost of filling a prescription; “Condition” data, specifying a condition being treated by the medication; and “Allergy” data, specifying any allergies associated with the medication. For a particular medication, the system presents values for both a set of predefined set of attributes (such as “Prescribing Physician” and “Prescription Date”) and machine-learning predicted attributes (such as “Status,”“Cost,”“Condition,”and “Allergies”).

One or more embodiments retrieve the additional attribute data for filtered query results predicted by the machine learning model from either the same data set retrieved in the query or from a separate data set obtained by executing a follow-up query. For example, an initial query to a database may return a set of records that includes an initial set of attributes and attribute values for the records. The machine learning model applied to the filter data may predict an attribute that is not among the set of attributes included with the set of records. The system constructs a follow-up query to the database to obtain the additional attribute and corresponding values. The system presents the additional attribute together with the filtered query results. For example, the filtered query results may return a list of doctor visits made by a patient to a set of doctors. The filtered results may also include any medications prescribed associated with visits. The machine learning model may predict the relevance of information specifying a doctor's specialty. The doctor's information may not be included in the set of data returned by the initial query. The system may execute a second query to obtain the doctors'specialty information. The machine learning model may also generate a prediction specifying information about test results associated with doctor visits. The test results may be included in the set of data returned by the initial query. The system retrieves the additional data and presents the additional data together with the filtered data.

One or more embodiments apply the machine learning model to a set of filtered query results to identify anomalies and discrepancies associated with the filtered query results. For example, a machine learning model trained to identify user selections over time may (a) present an attribute specifying that a presently prescribed medication is non-generic and (b) present an attribute specifying a generic alternative to the presently prescribed medication. As another example, the machine learning model may (a) present an attribute specifying that a presently selected physician is located a particular distance from a patient and (b) present an attribute specifying an alternative physician of the same time located closer to the patient.

In some embodiments, the machine learning model is trained to generate different predictions for different patient data and different classes of patients. For example, the training data set for training the machine learning model may specify different attributes presented to men versus women, for life-threatening conditions versus non-life-threatening conditions, for patients of varying income level, and for patients in different geographic locations. Consequently, the machine learning model may predict different attributes that a system may present with a filtered data set based for the same patient based on whether the condition associated with a database record is life-threatening or not. Additionally, the machine learning model may predict different attributes to present with a filtered data set for patients with the same condition but with different income levels or located in different geographic locations.

One or more embodiments described in this Specification and/or recited in the claims may not be included in this General Overview section.

### 2. Real-Time Query Results Attribute Determination Architecture

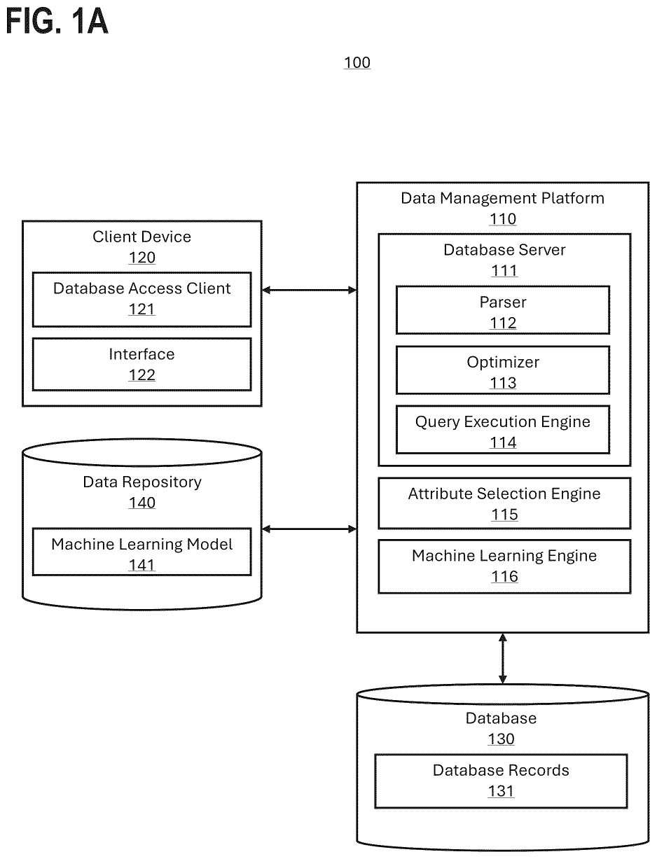

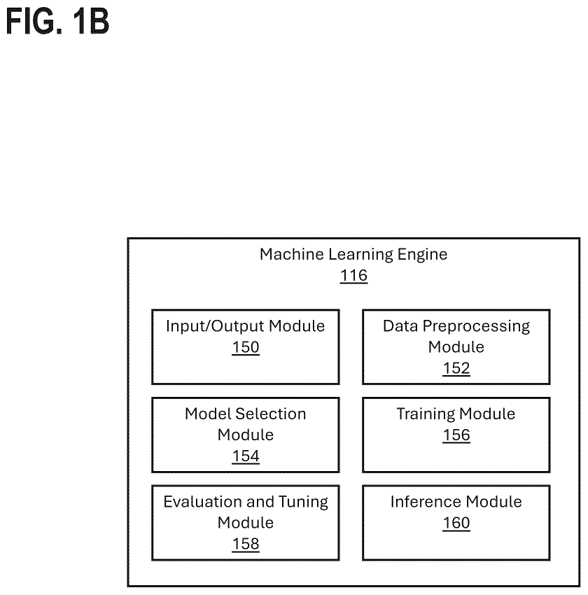

FIGS. 1A and 1B illustrate a system 100 in accordance with one or more embodiments. As illustrated in FIG. 1A, system 100 includes a data management platform 110, a client device 120, a database 130, and a data repository 140. In one or more embodiments, the system 100 may include more or fewer components than the components illustrated in FIG. 1A. The components illustrated in FIG. 1A may be local to or remote from each other. The components illustrated in FIG. 1A may be implemented in software and/or hardware. The components may be distributed over multiple applications and/or machines. Multiple components may be combined into one application and/or machine. Operations described with respect to one component may instead be performed by another component.

The data management platform 110 receives from a database access client 121 executing on the client device 120 an instruction associated with a set of database records 131 stored in the database 130. The data management platform 110 includes a database server 111 to manage queries to the database 130. The database server 111 processes requests by clients, including the database access client 121, to access the database 130. In one or more embodiments, the database server 111 manages database query requests by executing operations of a database management system (DBMS).

The DBMS includes operational modules, including a database engine, a storage manager, a query processor, a transaction manager, and a concurrency control component. The database engine interprets and executes incoming requests from the client device 120, manages data storage and retrieval, and ensures data integrity and security. The storage manager manages the physical storage of data in the system, including in the data repository 140 and the database 130. The storage manager allocates and deallocates disk space on a hard drive to store data in the database 130 and data associated with database queries. The query processor parses, optimizes, and executes queries written in a database query language. Some operations of the query processor are described in further detail below in connection with the parser 112, the optimizer 113, and the query execution engine 114. The query processor utilizes system resources, such as CPU, memory, and I/O components. In some embodiments, the query processor utilizes parallel processing for large-scale queries to improve performance. The query processor also handles error conditions and exceptions that may occur during query execution. The transaction manager ensures the DBMS satisfies atomicity, consistency, isolation, and durability requirements of the system. For example, the transaction manager implements locking mechanisms to prevent concurrent access to the same data by multiple transactions.

The database access client 121 interacts with the database server 111 by submitting to the database server 111 instructions that cause the database server 111 to perform operations on data stored in the database 130. For example, the application 121 may generate a database statement that conforms to a database language supported by the database server 111. According to one embodiment, the database access client 121 generates an SQL-type database statement.

The database 130 includes data and metadata stored on one or more memory devices such as on a set of hard disks. The database 130 stores the data and metadata according to a particular structure. According to one example, the database 130 stores data and metadata as a relational database construct. According to another example, the database 130 stores the data and metadata as an object-oriented database construct. According to yet another example, the database 130 stores the data in a hierarchical structure. In an embodiment in which the database 130 stores data in an object-oriented structure, one data structure is referred to as an object class, records are referred to as objects, and fields are referred to as attributes. In an embodiment in which the database 130 is a relational-type database, one data structure is referred to as a table, records are referred to as rows of the tables, and fields are referred to as columns. In an embodiment in which the database 130 stores data in a hierarchical data structure, data is stored in data objects that have pre-defined relationships to one another. For example, tables, rows, or other types of data objects may be hierarchically related to one another. These hierarchically related data objects may improve the storage efficiency of the data or the execution of different operations on the data. While examples of database structures and languages are provided for purposes of description, embodiments are not limited to any single type of database structure or language.

The database server 111 includes a query parser 112 and a query optimizer 113. The query parser 112 receives a query statement from the database access client 121 and generates an internal query representation of the query statement. According to an embodiment, the internal query representation represents different components and structures of a query statement. For example, the internal query representation may be represented as a graph of nodes. The internal representation is typically generated in memory for evaluation, manipulation, and transformation by a query optimizer 113.

The query optimizer 113 evaluates the internal query representation to generate a set of candidate execution plans for executing a query or set of queries. Execution plans specify an order in which execution plan operations are performed and how data flows between the execution plan operations. Execution plan operations include, for example, a table scan, an index scan, hash-join, sort-merge join, nested-loop join, and filter.

In one embodiment, the database access client 121 transmits to the database server 111 a request that includes a database statement corresponding to a set of records stored in the database 130. The parser 112 parses the database statement to identify the query terms corresponding to the set of records. The optimizer 113 generates an execution plan based on the internal query representation generated by the parser 112.

An attribute selection engine 115 determines a set of one or more attribute values to present with a query response. The database records 131 include sets of attributes and attribute values. For example, the database 130 may store a set of database tables. A row of a database table represents a database record. A column of the table represents an attribute. A value stored in a field at a juncture of the row and the column represents an attribute value of the database record for the attribute of the corresponding column. Attributes include properties of a database record. Examples of attributes include identifiers, types, quantities, or any other property.

In one embodiment, the database 130 stores database records 131 as a hierarchical data structure comprising nodes with defined relationships to other nodes. The nodes may represent entities. Entities include individuals, organizations, products, classes, types, and other nouns. The nodes may be characterized by node properties. The node properties specify characteristics of nodes. As used herein, node properties are referred to as attributes, and property values are referred to as attribute values.

The attribute selection engine 115 includes hardware and software components for selecting attributes to present in response to a query together with entity identifiers. Entity identifiers include identifiers of records, files, websites, nodes, or other data structures characterized by sets of attribute values. In an embodiments, the attribute selection engine 115 invokes a machine learning model 141 to predict one or more attributes. The one or more predicted attributes are not specified in the query received by the database server 111. In an embodiment, the one or more attributes may be either (a) among the set of attributes included in a set of records returned based on executing the query on the database 130 or (b) not among the set of attributes included in the set of records returned based on executing the query on the database 130. For example, the query may return a set of records that includes attributes A-L. The machine learning model 141 may generate a prediction specifying attributes M and N that are not included among the attributes A-L. Additionally, or alternatively, the machine learning model 141 may generate a prediction that specifies attribute G that is among the attributes A-L.

In one or more embodiments, the attribute selection engine 115 selects attribute values to present with a set of query results in real time, subsequent to executing the query. In other words, the database server 111 may not store predetermined attributes to present with query results. Additionally, or alternatively, the database server 111 may implement software code to present one or more attributes specified by query terms. The data management platform 110 may generate a data stream of data packets to the client device 120 that includes (a) one or more attribute values for attributes specified by query terms and (b) one or more attribute values for attributes not specified by query terms and selected by the attribute selection engine 115 subsequent to executing the query on the database 130.

In one or more embodiments, the attribute selection engine 115 selects one or more attributes for extracting values to include with a query response based on query terms, selected filters, or query results, where the attributes are not specified by the query terms or the selected filters. For example, a set of query terms may include terms that correspond to a particular patient and medications. The attribute selection engine 115 may generate a machine learning input vector that includes terms representing a patient identifier and the term “medications.” The machine learning model 141 may predict an attribute specifying the cost of a medication should be included with query results. The cost attribute may be included among attributes associated with medication-type database records. Alternatively, the cost attribute may be excluded from the attributes associated with the medication-type database records.

As another example, the attribute selection engine 115 selects one or more attributes for extracting values to include in a query response based on a filter applied to a query response. For example, a system may present a query response with a set of records representing a list of doctors. The system may present the list of doctors with a set of attributes A-C, including practice type and location. The system may receive a selection of a filter associated with the list of doctors such as “filter by distance.” The attribute selection engine 115 may provide the filter type to the machine learning model 141 as a component of an input vector. The machine learning model 141 may generate a prediction specifying an attribute “accepting new patients.” The attribute is not among the terms specified by the query or filter. However, the machine learning model 141 predicts, based on the relationships learned during training, that a search that includes doctors filtered by distance should return values regarding if the doctors are accepting new patients.

As another example, the attribute selection engine 115 selects one or more attributes for extracting values to include with a query response based on the records, files, nodes, or other entities identified by the database server 111 based on executing the query. The attribute selection engine 115 may determine that when a set of records includes a specified type, a query response that includes the records should include a particular value for a particular attribute.

In an embodiment, query execution engine 114 includes software code to access an application programming interface (API) of the attribute selection engine 115. The query execution engine 114 may, for example, execute a function of the API to transmit query results to the attribute selection engine 115. The attribute selection engine 115 may include software code for accessing the API of the machine learning engine 116. The attribute selection engine 115 may execute a function of the API to transmit input data to the machine learning engine 116. The input data includes query information, such a query terms, selected query filters, and query results identifiers.

FIG. 1B illustrates the machine learning engine 116. The architecture of the machine learning engine 116 is discussed in further detail in Section 3, “Machine Learning Architecture.”

In one or more embodiments, a data repository 140 is any type of storage unit and/or device (e.g., a file system, database, collection of tables, or any other storage mechanism) for storing data. Furthermore, a data repository 140 may include multiple different storage units and/or devices. The multiple different storage units and/or devices may or may not be of the same type or located at the same physical site. Furthermore, a data repository 140 may be implemented or executed on the same computing system as the data management platform 110. Additionally, or alternatively, a data repository 140 may be implemented or executed on a computing system separate from the data management platform 110. The data repository 140 may be communicatively coupled to the data management platform 110 via a direct connection or via a network.

The machine learning model 141 may be implemented across any of components within the system 100. However, this information is illustrated within the data repository 140 for purposes of clarity and explanation.

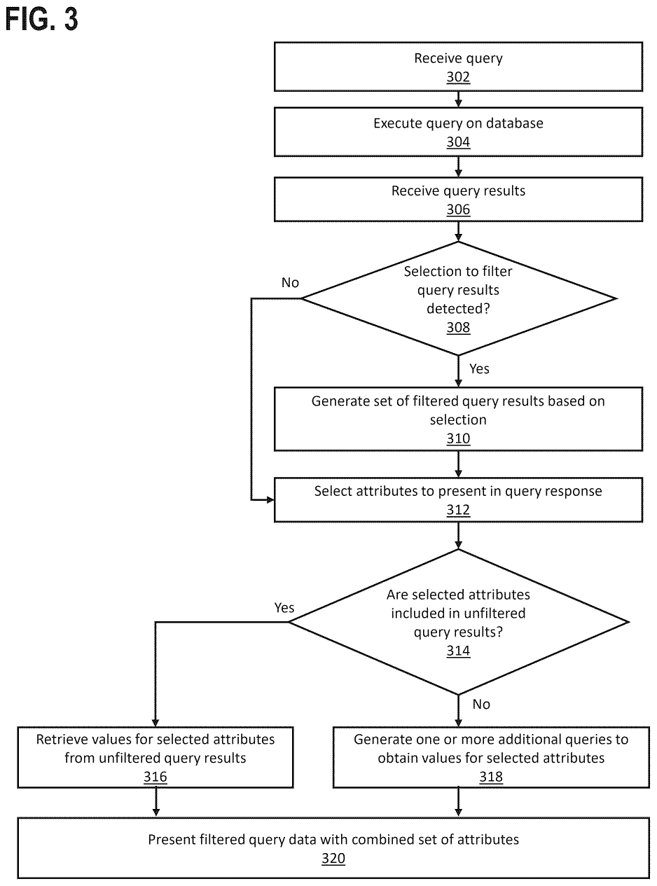

In one or more embodiments, the data management platform 110 refers to hardware and/or software configured to perform operations described herein for executing queries on the database 130, selecting attribute values to provide in a query response, and transmitting a query response to the client device 120. Examples of operations for selecting attributes for presenting in a query response in real time after executing a query are described below with reference to FIG. 3.

In an embodiment, the data management platform 110 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a server, a mainframe, a television, a content receiver, a set-top box, a printer, a mobile handset, a smartphone, and a personal digital assistant (PDA).

In one or more embodiments, interface 122 refers to hardware and/or software configured to facilitate communications between a user and the client device 120. Interface 122 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 122 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interface xyz is specified in one or more other languages, such as Java, C, or C++.

In one or more embodiments, the client device 120 receives inputs via the interface 122 while executing the database access client 121 to generate query terms and select filters for filtering query results. For example, the interface 122 may present a GUI that includes a text entry field for receiving query terms. The GUI may present selectable interface elements, including words and symbols, for generating query terms and applying filters to query results. Based on input received via the interface 122, the database access client 121 generates a set of data packets for transmission to the database server 111. The data packets include information for executing a query including query terms. The information for executing the query may further include metadata, such as a time the query was initiated, a user initiating the query, and one or more applications running on the client device 120. The data management platform 110 transmits data packets storing information, including query results, to the client device 120. The interface 122 presents the query results in the GUI.

### 3. Machine Learning Architecture

FIG. 1B illustrates a machine learning engine 116 in accordance with one or more embodiments. As illustrated in FIG. 1B, machine learning engine 116 includes input/output module 150, data preprocessing module 152, model selection module 154, training module 156, evaluation and tuning module 158, and inference module 160.

In accordance with an embodiment, input/output module 150 serves as the primary interface for data entering and exiting the system, managing the flow and integrity of data. This module may accommodate a wide range of data sources and formats to facilitate integration and communication within the machine learning architecture.

In an embodiment, an input handler within input/output module 150 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 150 to be versatile in different operational contexts, whether processing historical datasets or streaming data.

In accordance with an embodiment, input/output module 150 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 150 includes an output framework designed to handle the distribution and exportation of outputs, predictions, or insights. Using the output framework, input/output module 150 formats these outputs into user-friendly and accessible formats, such as reports, visualizations, or data files compatible with other systems. Input/output module 150 also ensures secure and efficient transmission of these outputs to end-users or other systems in an embodiment and may employ encryption and secure data transfer protocols to maintain data confidentiality.

In accordance with an embodiment, data preprocessing module 152 transforms data into a format suitable for use by other modules in machine learning engine 116. For example, data preprocessing module 152 may transform raw data into a normalized or standardized format suitable for training ML models and for processing new data inputs for inference. In an embodiment, data preprocessing module 152 acts as a bridge between the raw data sources and the analytical capabilities of machine learning engine 116.

In an embodiment, data preprocessing module 152 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 152 may be configured to handle anomalies in different ways depending on context. Data preprocessing module 152 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 152 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 152 processes new data for inference, data preprocessing module 152 replicates the same preprocessing steps to ensure consistency with the training data format. This helps to avoid discrepancies between the training data format and the inference data format, thereby reducing the likelihood of inaccurate or invalid model predictions.

In an embodiment, model selection module 154 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 154 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 154 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 154 may use these techniques to evaluate candidate models based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 154 also considers computational efficiency and resource constraints. This is meant to help ensure the selected model is both accurate and practical in terms of computational and time requirements. In an embodiment, certain features of model selection module 154 are configurable such as a configured bias toward (or against) computational efficiency.

In accordance with an embodiment, training module 156 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 156 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 156 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 156 includes logic to handle different types of data and learning tasks. For instance, it includes different training routines for supervised learning (where the training data comes with labels) and unsupervised learning (without labeled data). In the case of deep learning models, training module 156 also manages the complexities of training neural networks that include initializing network weights, choosing activation functions, and setting up neural network layers.

In an embodiment, evaluation and tuning module 158 incorporates dynamic feedback mechanisms and facilitates continuous model evolution to help ensure the system's relevance and accuracy as the data landscape changes. Evaluation and tuning module 158 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 158 performs continuous model tuning by using hyperparameter optimization. Evaluation and tuning module 158 performs an exploration of the hyperparameter space using algorithms, such as grid search, random search, or more sophisticated methods like Bayesian optimization. Evaluation and tuning module 158 uses these algorithms to iteratively adjust and refine the model's hyperparameters - settings that govern the model's learning process but are not directly learned from the data - to enhance the model's performance. This tuning process helps to balance the model's complexity with its ability to generalize and attempts to avoid the pitfalls of underfitting or overfitting.

In an embodiment, evaluation and tuning module 158 integrates data feedback and updates the model. Evaluation and tuning module 158 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 158 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 158 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 160 transforms data raw data into actionable, precise, and contextually relevant predictions. In addition to processing and applying a trained model to new data, inference module 160 may also include post-processing logic that refines the raw outputs of the model into meaningful insights.

In an embodiment, inference module 160 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 160 transforms the outputs of a trained model into definitive classifications. Inference module 160 employs the underlying model as a tool to generate probabilistic outputs for each potential class. It then engages in an interpretative process to convert these probabilities into concrete class labels.

In an embodiment, when inference module 160 receives the probabilistic outputs from the model, it analyzes these probabilities to determine how they are distributed across some or every potential class. If the highest probability is not significantly greater than the others, inference module 160 may determine that there is ambiguity or interpret this as a lack of confidence displayed by the model.

In an embodiment, inference module 160 uses thresholding techniques for applications where making a definitive decision based on the highest probability might not suffice due to the critical nature of the decision. In such cases, inference module 160 assesses if the highest probability surpasses a certain confidence threshold that is predetermined based on the specific requirements of the application. If the probabilities do not meet this threshold, inference module 160 may flag the result as uncertain or defer the decision to a human expert. Inference module 160 dynamically adjusts the decision thresholds based on the sensitivity and specificity requirements of the application, subject to calibration for balancing the trade-offs between false positives and false negatives.

In accordance with an embodiment, inference module 160 contextualizes the probability distribution against the backdrop of the specific application. This involves a comparative analysis, especially in instances where multiple classes have similar probability scores, to deduce the most plausible classification. In an embodiment, inference module 160 may incorporate additional decision-making rules or contextual information to guide this analysis, ensuring that the classification aligns with the practical and contextual nuances of the application.

In regression models, where the outputs are continuous values, inference module 160 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 160 incorporates domain-specific adjustments into its post-processing routine. This involves tailoring the model's output to align with specific industry knowledge or contextual information. For example, in financial forecasting, inference module 160 may adjust predictions based on current market trends, economic indicators, or recent significant events, ensuring that the outputs are both statistically accurate and practically relevant.

In an embodiment, inference module 160 includes logic to handle uncertainty and ambiguity in the model's predictions. In cases where inference module 160 outputs a measure of uncertainty, such as in Bayesian inference models, inference module 160 interprets these uncertainty measures by converting probabilistic distributions or confidence intervals into a format that can be easily understood and acted upon. This provides users with both a prediction and an insight into the confidence level of that prediction. In an embodiment, inference module 160 includes mechanisms for involving human oversight or integrating the instance into a feedback loop for subsequent analysis and model refinement.

In an embodiment, inference module 160 formats the final predictions for end-user consumption. Predictions are converted into visualizations, user-friendly reports, or interactive interfaces. In some systems, like recommendation engines, inference module 160 also integrates feedback mechanisms, where user responses to the predictions are used to continually refine and improve the model, creating a dynamic, self-improving system.

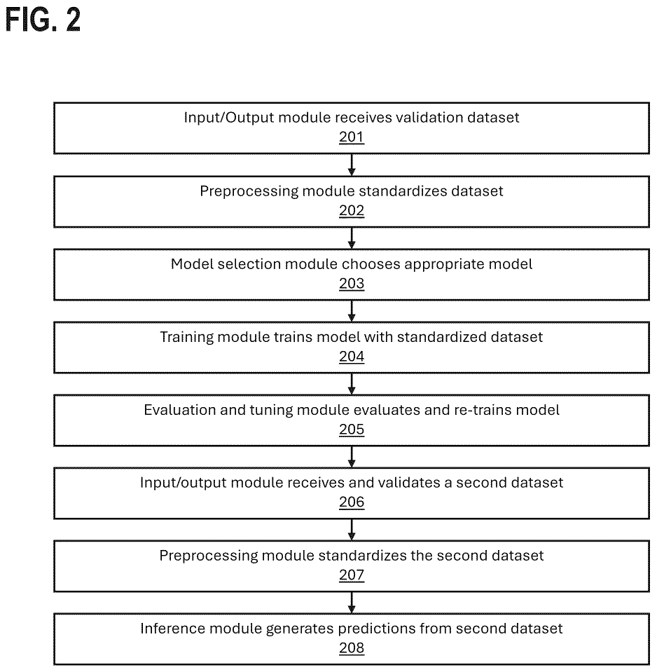

FIG. 2 illustrates the operation of a machine learning engine in one or more embodiments. In an embodiment, input/output module 150 receives a dataset intended for training (Operation 201). This data can originate from diverse sources, like databases or real-time data streams, and in varied formats, such as CSV, JSON, or XML. Input/output module 150 assesses and validates the data, ensuring its integrity by checking for consistency, data ranges, and types. In embodiments, the dataset includes database queries and/or database query responses. The database queries may include query terms, metadata, and filters applied to query responses.

In an embodiment, training data is passed to data preprocessing module 152. Here, the data undergoes a series of transformations to standardize and clean it, making it suitable for training ML models (Operation 202). This involves normalizing numerical data, encoding categorical variables, and handling missing values through techniques like imputation.

In an embodiment, prepared data from the data preprocessing module 152 is then fed into model selection module 154 (Operation 203). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 156 trains the selected model with the prepared dataset (Operation 204). It implements learning algorithms to adjust the model's internal parameters, optimizing them to identify patterns and relationships in the training data. Training module 156 also addresses the challenge of overfitting by implementing techniques, like regularization and early stopping, ensuring the model's generalizability. In embodiments, the training module 156 trains the selected model to predict attributes for query data. The predicted attributes may be based on historical attribute selections and/or historical data specifying relevant attributes associated with historical queries.

In an embodiment, evaluation and tuning module 158 evaluates the trained model's performance using the validation dataset (Operation 205). Evaluation and tuning module 158 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 150 receives a dataset intended for inference. Input/output module 150 assesses and validates the data (Operation 206).

In an embodiment, data preprocessing module 152 receives the validated dataset intended for inference (Operation 207). Data preprocessing module 152 ensures that the data format used in training is replicated for the new inference data, maintaining consistency and accuracy for the model's predictions.

In an embodiment, inference module 160 processes the new data set intended for inference, using the trained and tuned model (Operation 208). It applies the model to this data, generating raw probabilistic outputs for predictions. Inference module 160 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, a machine learning engine API allows for applications to leverage machine learning engine 116. In an embodiment, machine learning engine API may be built on a RESTful architecture and offer stateless interactions over standard HTTP/HTTPS protocols. Machine learning engine API may feature a variety of endpoints, each tailored to a specific function within machine learning engine 116. In an embodiment, endpoints such as /SubmitData facilitate the submission of new data for processing, while /retrieveResults is designed for fetching the outcomes of data analysis or model predictions. The MLE API may also include endpoints like /updateModel for model modifications and /trainModel to initiate training with new datasets.

In an embodiment, the machine learning engine API is equipped to support SOAP-based interactions. This extension involves defining a WSDL (Web Services Description Language) document that outlines the API's operations and the structure of request and response messages. In an embodiment, machine learning engine API supports various data formats and communication styles. In an embodiment, the machine learning engine API endpoints may handle requests in JSON format or any other suitable format. For example, machine learning engine API may process XML, and it may also be engineered to handle more compact and efficient data formats, such as Protocol Buffers or Avro, for use in bandwidth-limited scenarios.

In an embodiment, the machine learning engine API is designed to integrate WebSocket technology for applications necessitating real-time data processing and immediate feedback. This integration enables a continuous, bi-directional communication channel for a dynamic and interactive data exchange between the application and machine learning engine 116.

### 4. Generative Models

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks like unsupervised learning, semi-supervised learning, and domain adaptation.

One type of generative model is a large language model. Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a SoftMax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 150, when used for large language models, handles textual data, converting input text into a format that the model can process. This typically involves tokenization, where the text is broken down into manageable pieces, such as words or subwords, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 152 in the context of large language models may include steps such as normalization, where the text is converted to a uniform case and punctuation is standardized. This process ensures that the model treats similar words or symbols consistently, reducing the complexity of the input space. Additionally, techniques such as sentence segmentation may be applied to manage longer texts, enabling the model to process information in chunks that align with natural language structures.

In accordance with one or more embodiments, model selection module 154, when used for large language models involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 156, when used for large language models, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware such as GPUs (Graphics Processing Units) or TPUs (Tensor Processing Units) to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 158 assesses the performance of large language models using metrics such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 160, in the context of large language models, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). A large multimodal model is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of large multimodal models. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

### 5. Selecting Attributes to Display for a Set of Search Results

FIG. 3 illustrates an example set of operations for selecting attribute to display with a set of query search results in accordance with one or more embodiments. One or more operations illustrated in FIG. 3 may be modified, rearranged, or omitted. Accordingly, the particular sequence of operations illustrated in FIG. 3 should not be construed as limiting the scope of one or more embodiments.

A system receives a query (Operation 302). A system may receive the query based on text entered in a text entry field, selections of interface elements in a GUI presented on a client computing device, and data requests initiated by applications running on computing device. The query includes a set of query terms. The query may be accompanied by additional information such as metadata. Query metadata includes a time that a query was initiated or that query terms were received by the client computing device. Query metadata further includes user information and application information. For example, a system may support a human resources application and a billing application. The applications may have access to the same database. The metadata may specify the application where the query originated, such as the human resources application or the billing application.

In an embodiment, a client device generates a set of data packets that include the query information. The client device transmits the data packets to a data management platform that includes a database server. The data management platform unpacks and decodes the data packets to enable the database server to execute the query.

A system executes a query on a data set stored in a database (Operation 304). The system may receive a request to execute a query to access data stored in a database. The request may be received based on a user interacting with a set of data presented in a user interface. An application running on the user device and presenting the user interface generates the request based on detecting the user interaction with the user interface. The application may transmit the request to a database server. The database server may compose a Structured Query Language (SQL) query or a query in a database language. The query includes elements specifying, for example, a table stored in the database, a portion of a table (such as a column), filters to apply to results, groupings to apply to results, and an order for returning results. In some embodiments, the system stores records in tables. One column of the table specifies a record identifier such as a record name. In some embodiments, record names represent entities, such as individuals, organizations, types, objects, and other nouns. Additional columns specify attributes of the records in the table. The system executes the operations specified in the SQL query to identify a set of records stored in the database that match the query terms.

In some embodiments, the system stores records in a hierarchical data structure. The hierarchical data structure includes interconnected nodes representing entities.

The system receives a set of query results based on executing the query (Operation 306). For example, the database server may transmit a set of database records to the application on the user device in response to the request. The query results include different types of data records. A database may store one type of data records in one table and another type in another table. The query results may include records from the respective tables. As an example, a patient portal user interface may generate a request to access patient medical data. The medical data may include medical provider records from a medical provider table, medication records from a medication table, and medical testing records from a medical test table. In some embodiments, a record type may be an attribute in another table. For example, a table storing data for medical conditions may include a medical provider attribute. A value for the attribute may be a name for medical providers that treat the condition. Additionally, or alternatively, the value for the attribute may include a link to another table.

In some embodiments, the database stores data as a set of hierarchal nodes. A node for a patient may link to nodes for medical providers, medications, and treatments.

The system detects if a selection to filter the set of query results is received (Operation 308). For example, the system may detect a user interaction with an interface element of a GUI to select one or more filters. The system may present record types and attribute names as filters. In some embodiments, the system presents attribute values as filters.

The system generates filters to present in the GUI based on query information, hard-coded default filters, and/or user information. As an example, a set of query results may include ten associated attributes. The system presents either all ten attributes or a subset of the ten attributes. For example, the system may present the first five attributes in order as they are stored in a table based on space available in the GUI. The system may determine a filter to present in the GUI based on the ten attributes. A filter may include a name of the attribute or a value of the attribute. In an embodiment where a dataset is stored as a hierarchy of nodes, a filter may include a name of a node, a node type, or a name of a node property. In an embodiment where a dataset is stored as a set of tables, a filter may include a name of a table, a name of an attribute that appears as a column header in a table, an attribute value, or a range of attribute values.

The system generates a set of filtered query results according to the filter selection (Operation 310). The filtered query results includes a subset of query results based on a selected filter. In some embodiments, presenting the filtered query results includes modifying the data presented beyond merely changing a number of query results presented. The system may change a set of attributes and/or attribute values that is presented to represent records in the filtered set of query results. For example, upon returning a set of data in response to executing a query, the system may record names and one or more attribute values for the database records. In one example, the system organizes and presents the data according to date. In another example, the system organizes and presents the data in alphabetical order according to a record name. In yet another example, the system categorizes the records according to type and organizes the records within each record type by date, by alphabet, or based on any other predefined criterion.

The system presents, together with a set of displayed records, a subset of attribute values for attributes associated with the record. When the system displays the initial and unfiltered set of records in response to the query, the system may select a default set of attributes to display for the records. If a record includes ten attributes, the system may select two or three attributes to display. The system may refrain from displaying the remaining attributes. However, a user may navigate to views that include the remaining attributes. For example, selecting a particular record by a user may cause the system to display all the attributes and attribute values for the record.

When the system displays the initial and unfiltered set of records in response to the query, the system may select different default sets of attributes to display for different record types. For example, a medication record type may include ten attributes. The system may display values for a subset of three attributes, including a medication name, a prescription date, and value representing if the prescription is still active. A medical provider record type may also include ten attributes. The system may display values for a subset of two attributes, including a provider name and the date of the patient's most recent visit.

When the system generates the set of filtered query results, the system may also change the user interface by changing the attributes displayed for a set of records. For example, if the user selects a filter, “medication”, the system may change the user interface from displaying three attributes to displaying four attributes of the record type “medication.” Additionally, or alternatively, the system may change the displayed attributes. Instead of displaying the prescription date and a value indicating a prescription is active, the system may display a dosage value and a condition that is treated by the medication. In addition, selection of the medication type filter causes the system to refrain from presenting records of the medical provider type, condition type, and test results type in the user interface.

The system selects a set of attributes to present in a query response (Operation 312). An attribute selection engine 115 may receive query results from a query execution engine 114 of a database server 111. The query execution engine 114 may execute a function of an attribute selection engine API to transmit the query results from the database server 111 to the attribute selection engine 115. In some embodiments, the database server 111 transmits additional query information to the attribute selection engine 115, including information about a user initiating a query, query terms, and selected query filters. Information about a user initiating the query may include user demographic information, user profile information, and search and/or query history information.

The attribute selection engine 115 includes software code executed in a computer to perform operations for selecting attributes to present in a query response. Selecting attributes to present in a query response may include selecting from among a set of attributes included in records returned by the query and selecting attributes to present that are not among the attributes included in the records returned by the query. Selecting attributes to present in a query response may include inferring a correlation between one or more attributes and query information, and selecting the attributes based on a strength of the correlation.

In one or more embodiments, the system applies a machine learning model to a set of query data to generate predictions of relevant attributes to present in a set of query results. The machine learning model may learn during training correlations among query information and attributes. Query information may include a set of filter data associated with a selected filter for filtering the query results, query terms, and attribute values or properties of records returned based on executing the query. The set of filter data may include a name of a data filter or the filtered data set. Filter data may further include user data. For example, the system may provide the machine learning model with data representing frequently accessed attributes and values of database records, recently accessed attributes and values of database records, the user's sex, age, location, income category, nationality, race, ethnicity, and marital status. In an example where the system presents a user's medical data, the system may provide the machine learning model with medical history data of the user.

In one or more embodiments, the machine learning model generates predictions for additional attributes and values to present together with one or more default attributes of the filtered set of query results. A default attribute is an attribute selected based on hard-coded software programming. For example, one default attribute is a record name. The system may present values for one or more additional default attributes for the filtered set of query results. The system presents one or more values for additional attributes predicted by the machine learning model together with the values for the default attributes.

In one embodiment, additional attributes are based on identifying anomalies or discrepancies by the machine learning model. For example, the machine learning model may predict a set of values for a set of attributes corresponding to a user selecting a filter. The system may compare the predicted values to the values for the attributes stored in the database. The system may generate predictions that include recommendations for (a) attributes to display and (b) recommended values for the attributes based on the machine learning model. As an example, if a user selects a medication type filter, the machine learning model may generate a recommended value “Yes” for an attribute “Generic.” The system may determine that a medication record stored in the database that is prescribed to the user has a “No” value for the attribute “Generic.” The system may further analyze additional data sets to determine if a generic medication exists that corresponds to the presently prescribed medication. Based on the machine learning model identifying an anomaly, the system may (a) present an attribute “Generic” for a set of displayed medications, (b) present a value “No” for at least one medication, and (c) recommend an alternative medication associated with the same condition and that includes a value “Yes” for the attribute “Generic.”

In one or more embodiments, the system selects attributes to present with search results based on an entity type, such as a record type, associated with one or more database records. The system may input a value for “type” to the machine learning model as input data to enable the model to generate a prediction of one or more relevant attributes based on the type. The system may obtain the type from a data field included in a set of records returned based on executing a query. Additionally, or alternatively, the system may infer the type from other information, such as a record name, query terms, or query filters.

In one or more embodiments, the system selects attributes to present with search results based on a time associated with the query. For example, the system may generate a timestamp when a query is received by a client computing device and/or received by a database server. The system may store the timestamp as metadata associated with a specified set of query terms. The system may input a value for the time to the machine learning model as input data to enable the model to generate a prediction of one or more relevant attributes based on the time.

In one or more embodiments, the system selects attributes to present with search results based on a distance associated with the query. For example, the system may access location information in a client computer when a query is received by a client computing device and/or received by a database server. The system may store the location information as metadata associated with a specified set of query terms. The system may input a value for the distance to the machine learning model as input data to enable the model to generate a prediction of one or more relevant attributes based on the distance.

In one or more embodiments, the machine learning model generates a prediction that includes a ranked set of attributes. The machine learning model may rank the attributes according to their predicted relevance to a query. The system may select one or more of the attributes to present with a set of search results based on the ranking of the attributes.

The system determines if the selected attributes are included in the data set returned in response to the query (Operation 314). For example, a set of records returned in response to the database query may include three types of database records. The records may include varying numbers of corresponding attributes. A first record type includes five attributes. A second record type includes ten attributes. A third record type includes seven attributes. If a user selects a filter corresponding to the second record type and ten record attributes, the system determines if the attributes predicted by the machine learning model are among the ten attributes.

In an example where a database record is stored as a table, the system analyzes column headers of the table to determine if the selected attributes are included in the data set returned in response to the query. The column headers may specify attribute names and other identifiers. In some embodiments, the column headers specify abbreviations or representations of attribute names. The system may refer to a mapping of attribute names to abbreviations and representations of the attribute names to determine the attributes represented in a table. In some embodiments, the column headers specify encoded attribute names. The system may apply a decoding algorithm or refer to a hashing table to decode an attribute name specified in a column header. In some embodiments, executing a query includes returning records from linked database tables. Determining if the selected attributes are included in the data set may include traversing table links to (a) identify a combined set of attributes from the set of linked tables and (b) determining if the selected attributes are included among the combined set of attributes among the set of linked tables.

In an embodiment where a database record is stored as a hierarchy of linked nodes, the system traverses the hierarchy of linked nodes to determine if the selected attributes are included among the node properties of the hierarchy of linked nodes.

If the selected attributes are included in the data set returned by the query, the system extracts the values for the attributes from the data set (Operation 316). In the above example where the user selects a filter corresponding to a record type with ten attributes, the system determines that the machine learning model has predicted the ninth attribute as being relevant to the query. The system extracts a value for the ninth attribute and stores the value together with the record name. In an embodiment, a query execution engine 114 encodes the value, attribute name, and record name in a data packet for transmission to a database access client 121 that initiated the query. The system may extract a value for the ninth attribute from a set of records returned by the query. For example, if a query execution engine 114 retrieves twenty database records in response to executing a query, the system may extract the values for the ninth attribute from the twenty database records. A query execution engine 114 may encode the values, the attribute name, and the record names in one or more data packets for transmission to a database access client 121 that initiated the query.

If the system determines the selected attributes are not included in the data set returned by the query, the system generates and executes one or more additional queries to retrieve the additional attributes and values from additional data sets of database records (Operation 318). For example, a set of attributes associated with a medication type record may omit an attribute, “Allergies.” However, the machine learning model may predict the attribute, “Allergies,” is relevant to a query even though the query terms and selected filters do not specify the word “allergies” or any root or derivative of the word. The system generates and executes an additional query to retrieve a value for an attribute, “Allergies,” for the medication type records in the filtered data set.

In one or more embodiments, the execution of the additional query is performed automatically, without user intervention, to enrich an original set of query results with additional data that includes additional attribute values for additional attributes. For example, a query execution engine of a database server may execute a query on a database and return an initial set of results. The initial results include an initial set of database records and a corresponding initial set of attribute values for an initial set of attributes. The database server inputs query information, including record types of records returned by the query execution engine, to a machine learning model. The database server receives a set of predicted attributes from the machine learning model. The predicted attributes are predicted by the machine learning model to be relevant to the query results based at least on the types of records returned by the query. An attribute selection component of the database server determines that at least one of the additional attributes predicted by the machine learning model is not among the initial set of attributes. The attribute selection module generates query terms for an additional query. The query execution engine of the database server executes the query to retrieve a set of additional records. The attribute selection engine may structure the query terms to specify an association between the record types of the initial set of records returned in the initial query results and the one or more additional attributes. Based on receiving an additional set of query results, the system matches one or more additional attributes returned in a set of additional database records in response to the additional query with the initial set of database records. The database server may generate a set of query results that includes (a) an entity identifier, such as a name of a database record, (b) one or more attribute values of an initial attribute returned in the initial query, and (c) one or more attribute values of an additional attribute returned in the additional query. The database server structures the combined set of initial and additional attributes as a single set of attributes. A client device presenting the query response to the initial query may not distinguish between the attributes returned by the initial query and additional attributes returned by the additional query.

In one or more embodiments, executing one or more additional queries includes retrieving additional database records that were not retrieved in an initial query. The additional database records may be records linked to database tables referenced in the initial query. Alternatively, the additional database records may be unlinked by pointers, uniform resource locators (URLs), or other computer code that would direct a computer from one set of database tables to another set of database tables. In an embodiment, a system identifies and analyzes the contents of an index that stores attribute names in a database to identify tables and/or hierarchical nodes that include selected attributes.

For example, a system may execute an initial query to return an initial set of query results. Based on a machine learning model prediction, the system analyzes a database index to locate an attribute not included among the initial set of query results. Based on identifying the attribute in the database index, a query execution engine 114 generates a new query that includes a set of query terms referencing the selected attribute and at least one linking term that links the selected attribute to the initial set of query results. The query execution engine 114 executes the new query to return a new set of query results that includes records from at least one database table that did not provide any records in the initial set of query results. The system links the new set of query results to the initial set of query results. The system presents a query response that includes (a) an entity identifier associated with a database record, (b) at least one attribute included in the initial set of query results, and (c) the selected attribute included in the new set of query results. A client device presents the query response in a GUI. The client device visually merges the results from the multiple queries by presenting the entity identifier, the attribute from the initial set of query results, and the attribute from the new set of query results in a uniform presentation format.

In one or more embodiments, the system executes the additional query to retrieve database records, including the selected attribute automatically, without user intervention, and prior to presenting any results to a querying client device. In other words, a database server 111 receives a query request from a database access client 121. The database server 111 executes the initial query, receives the follow-up query from the attribute selection engine 115, executes the follow-up query, combines the results of the multiple queries, encodes the combined results for transmission to the database access client 121, and transmits the combined results to the database access client 121. The database access client 121 receives the combined results without receiving any indication that the results are made up of attributes obtained from multiple different queries, including a follow-up query performed subsequent to retrieving an initial set of query results.

In embodiments, the prediction of relevant attributes by the machine learning model and the execution of an additional query to obtain values for the additional attributes improves a computer's ability to retrieve data by reducing transactions between a database server and a client computer, thereby preserving bandwidth and processing capacity. The prediction of relevant attributes by the machine learning model and the execution of an additional query based on the prediction reduces the need for transmitting one set of query results to a client device only to receive additional requests for additional queries to the database from the client device as a user requests additional information about query results. Furthermore, the database server may cache an initial query and/or initial set of records returned by the initial query as the additional query is executed. The database server may then access the cached data to supplement the cached database records'attributes with additional attributes retrieved in the additional query. The automatic execution of the additional query by the database server enables the utilization of cache memory to increase the efficiency and speed of the combined query execution and query results presentation operations by the database server.

In one or more embodiments, the system obtains attribute values for one or more predicted attributes using a generative AI model. The system may determine the database does not include records that include a selected attribute predicted by the machine learning model to be relevant to the query. The system may generate a generative AI prompt to obtain a value for the attribute. The system inputs the prompt to the generative AI model and receives one or more attribute values from the generative AI model. The system incorporates the attribute values received from the generative AI model with attribute values extracted from database records in a set of query results.

In one or more embodiments, the system obtains the attribute values for the one or more predicted attributes using the generative AI model in combination with a web search. The system may generate a set of web search terms to identify a set of websites that include information about the predicted attribute. The system may provide the websites as a link or attachment in the generative AI prompt directing the generative AI model to obtain attribute values for the predicted attribute from the selected set of websites.

The system presents the filtered query data with a combined set of attributes and values in the user interface (Operation 320). In one example, the system presents the attributes and values in a table-type format. For example, the system may present an attribute name above or alongside a corresponding value. In another example, the system identifies a graphic for presenting the attributes and values. For example, the system may detect a user selection of a record type “Test Results.” The machine learning model may predict a set of attributes “normal range,” “upper anomalous range,” and “lower anomalous range” associated with the record. The system may generate an additional query to obtain values for the machine learning model predicted attributes. The system may identify a bar graph as a graphic for displaying the record and attribute data. Accordingly, the system may present a bar, including different-colored portions corresponding to a normal range and anomalous ranges, in the user interface. The system may include a graphic element, representing a patient's test results along the bar graphic.

In the embodiment described above, the system inputs filter information to a machine learning model to generate predictions of attributes to include in query results. Additionally, or alternatively, in some embodiments, the system may input query information including (a) query terms and/or (b) query results information into the machine learning model. For example, the system may execute a query to retrieve a set of records from a database. The system may identify a set of attributes or properties associated with the set of records. The system may identify a “type” associated with the set of records. Identifying the “type” may include extracting values from a data field associated with a “type” attribute. Additionally, or alternatively, identifying the “type” associated with the set of records may include engineering a generative AI prompt that includes a set of record identifiers and instructions to identify a type that the records have in common. According to another example, identifying the type associated with the set of records may be a determination inherent in the trained machine learning model learned that is learned by the model during training. The system may provide records data, such as record identifiers or names, to the machine learning model. The model may generate predictions of relevant attributes without specifying the type of the records.

In one or more embodiments, the system may skip operations 308 and 310 to select a set of attributes to present with query results without considering if a filter has been selected. Alternatively, the system may select the attributes to present with the query results based on a combination of two or more of query terms, selected filters, and query results obtained from executing the query. In embodiments where the system selects attributes based on query terms and selected filters, the selected attributes include one or more attributes not specified by the query terms or the selected filters. Instead, a machine learning model or other software model may infer relevant attributes from the query information input to the model.

In one or more embodiments, the system selects a different set of attributes and corresponding values to present with different records returned by the query. For example, the system may identify a first database record returned by a database server as a first type of record such as a record obtained from a “Doctors” table in a database. The record includes attributes associated with doctors, such as a name, a type of practice, location, years of experience, associated hospitals, etc. The system may identify a second database record returned by the database server as a second type of record such as a record obtained from a “Tests” table in the database. The record includes a name of a medical test, a date administered, an administering medical professional, an associated hospital or location, medications prescribed, and a hyperlink to test results. The machine learning model may predict a first attribute to present with the “Doctor” type record and a second attribute to present with the “Tests” type record. The first attribute may be different from the second attribute. The different records with the different sets of attributes may be presented concurrently with the same set of query results.

### 6. Example Embodiment

A detailed example is described below for purposes of clarity. Components and/or operations described below should be understood as one specific example that may not be applicable to certain embodiments. Accordingly, components and/or operations described below should not be construed as limiting the scope of any of the claims.

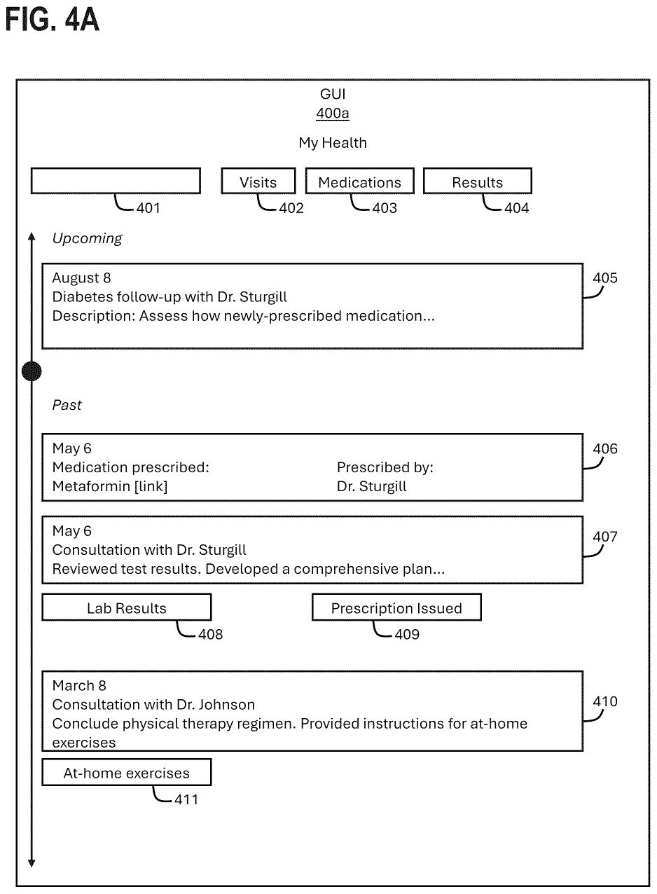

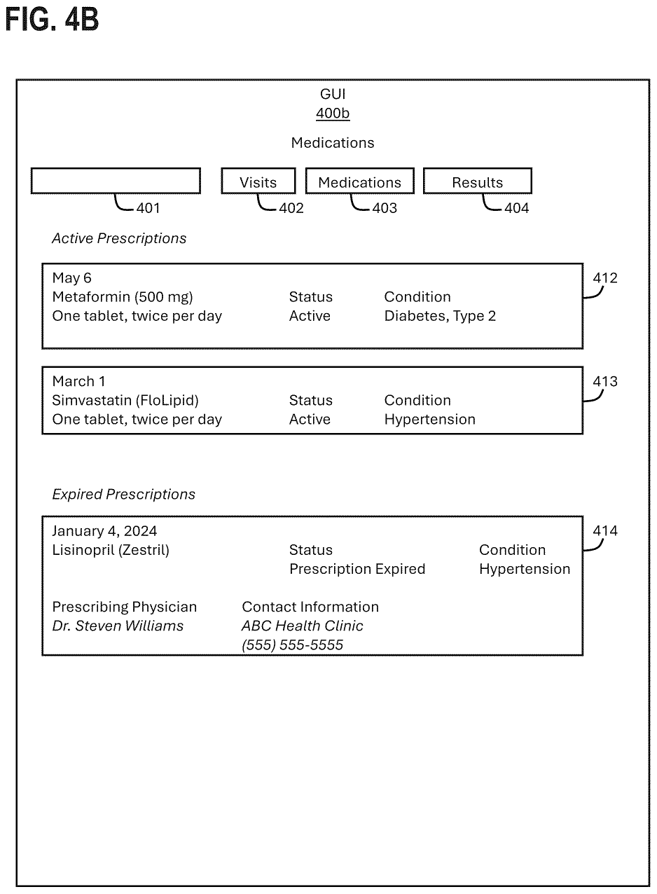

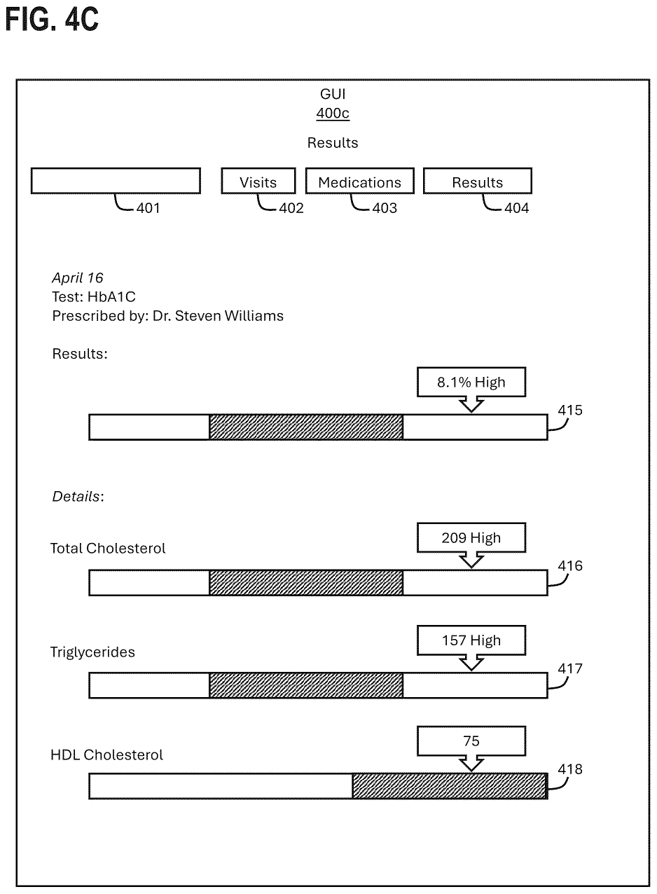

FIG. 4A illustrates a GUI 400a presenting user interface elements associated with a patient health management application. The GUI 400a includes a text entry field 401 to receive a text input specifying one or more query terms. The GUI 400a presents interface elements 402, 403, and 404 specifying query filters to apply to queries.

The GUI 400a presents query results for a query accessing health information for a patient. Based on a user navigating to the GUI 400a, a client computer initiates a query that specifies (a) the patient's identity (or an identifier) and (b) one or more query terms associated with the patient's health, such as “medical,” “diagnosis,” “condition,” “medications,” and “doctor visits.” Based on the query terms, a query server executes a query on a database to retrieve records associated with the patient. The database includes multiple linked tables. One table specifies doctors, one specifies medications, and one specifies office visits. For example, the table specifying doctors includes attributes for “name,” “address,” “years'experience,” “practice area(s),” “number of times visited,” and “accepting patients.” The table specifying medications includes fields for “name,” “additional names,” “cost,” “prescribing physician,” “dispensing pharmacy,” “date prescribed,” “alternate pharmacy,” “usage instructions,” “status” (e.g., active, lapsed), “date lapsed,” “refill available (Y/N).” The “medications” table may include a link to the “Doctors” table that links the prescribing physician value for the prescribing physician attribute to a record specifying a particular physician in the “Doctors”table.

An attribute selection engine receives a set of query results based on the query. The query results include records obtained from a “Visits” database table and a “Medications” database table. The “Visits” database table stores values for one set of attributes. The “Medications” database table stores values for a different set of attributes. The system provides query information, including query terms and query results, to a machine learning model trained to predict relevant attributes for queries. The system provides two separate sets of input data to the machine learning model. One set of input data corresponds to the records retrieved from the “Visits” database table. The other set of input data corresponds to the records retrieved from the “Medications” database table. The machine learning model generates a first prediction based on the first set on input data. The first prediction predicts an attribute, “doctor name,” is relevant to the query and set of records associated with the “Visits” table. The system presents the value “Dr. Strugill” for the attribute “doctor name” in a query result 405 associated with an August 8 doctor visit. The system presents the value “Dr. Strugill” for the attribute “doctor name” in a query result 407 associated with a May 6 doctor visit. The system presents the value “Dr. Johnson”in a query result 410 associated with a March 8 doctor visit.

The system presents values for additional attributes, including “visit date,” “visit description,” “prescriptions issued,” and “lab tests,” together with the predicted attribute “doctor name.” The selection of the attributes, including “visit date,” “visit description,” “prescriptions issued,” and “lab tests,” may be hard-coded default attribute values or values specified by query terms. The system presents the value for the attribute predicted by the machine learning model as being relevant to the query together with the attribute values based on hard-coded default attributes.

The GUI 400a presents interface element 408 that links to lab results referenced in the “Visits” database table. The GUI 400a presents interface element 409 that links to prescription information references in the “Visits”database table.

The machine learning model generates a second prediction based on the second set on input data. The second prediction predicts an attribute, “prescribing physician,” is relevant to the query and set of records associated with the “Medications” table. The system presents the value “Dr. Strugill” for the attribute “prescribing physician” in a query result 406 associated with a May 6 prescription of Metformin. The system presents additional values for additional attributes “Medication Name” and “Prescription Date.”

As illustrated in FIG. 4B, based on receiving a selection of a filter, “Medications,” corresponding to the interface element 403, the system modifies a set of displayed data in the GUI 400b. Notably, the system presents one set of attribute values associated with records in a “Medications” database table based on receiving a first query associated with FIG. 4A. The system presents a different set of attribute values in FIG. 4B for a different set of attributes for the same set of records that were presented in FIG. 4A based on receiving a different combination of query terms, filters, and/or query results associated with FIG. 4B. In particular, based on detecting the selection of the interface element 403 associated with the “Medications” filter, the system generates a set of input data to the machine learning model that includes a filter type “medications.” The machine learning model generates a prediction that includes two attributes, “status” and “condition.” The system presents query results 412, 413, and 414 in the GUI 400b. The query results include values for the attributes “status” and “condition.”

The query result 412 is associated with a database record for a medication named “Metformin,” prescribed on May 6. The query result 412 is associated with the same database record as the query result 406, illustrated in FIG. 4A. However, the system presents a different set of attribute values for a different set of attributes associated with the same database record based on the machine learning model, predicting different sets of relevant attributes. In the process represented in FIG. 4A, where a filter, “medications,” had not been selected, the machine learning model generated a first prediction of a relevant attribute. Based on including the filter “medications” to the input data provided to the machine learning model, the model generated a second prediction of relevant attributes as illustrated in FIG. 4B.

The system further presents a representation of the attribute “Active/Expired” by presenting query results 412 and 413 under a heading “Active Prescriptions” and the query result 414 under the heading “Expired Prescriptions.” In the embodiment illustrated in FIG. 4B, the system generates a separate set of input data to input to the machine learning model for records that include the attribute value “expired.” The machine learning model generates a prediction that for query records with the “expired” attribute, the attributes “prescribing physician” and “contact information” are relevant attributes. In other words, the machine learning model predicts different relevant attributes associated with query results that have different attribute values.

The system determines that the attribute “contact information” is not included in the database record for the medication “Lisinopril.” The system generates a set of follow-up query terms that include the prescribing physician “Dr. Steven Williams” and the attribute “contact information.” A query execution engine executes the query to return a set of records from the “Doctors” database table. The system presents the query result 414 that combines attribute values from the “Medications” database table with the attribute value “ABC Health . . . ” extracted from the “Doctors” database table in response to the follow-up query. The system transmits the combined query results from the initial query and the follow-up query to a client device presenting the GUI 400b.

As illustrated in FIG. 4C, based on receiving a selection of a filter “Results,” corresponding to the interface element 404, the system modifies a set of displayed data in the GUI 400c. Based on detecting the selection of the interface element 404 associated with the “Results” filter, the system generates a set of input data to the machine learning model that includes a filter type “results” and omits the filter “medications.” The machine learning model generates a prediction that includes attribute “relative magnitude.” The system presents a query result 415 that includes attribute values for attributes “date,” “test name,” and “prescribing physician.” The query result 415 further includes graphical representations of values included in a “details” attribute. The values include a value “209” for a “total cholesterol” attribute, a value “157”for a “triglycerides”attribute, and a value “75”for an HDL cholesterol attribute.

The system determines that the “relative magnitude” attribute is not included in the attributes for the set of records returned by the query. The system generates a generative AI prompt to obtain attribute values for the attribute “relative magnitude.” For example, a generative AI prompt may include the instructions, “Rate a total cholesterol level of 209 as ‘normal,’ ‘high,’ or ‘dangerous.’” The system provides the generative AI prompt to a generative AI model and receives a response that includes an attribute value of “high” for the attribute “relative magnitude.” The system generates additional prompts for the attributes “triglycerides” and “HDL cholesterol.” The system generates a set of query responses that includes (a) attribute values included in the database records and (b) the additional attribute values for the additional attribute “relative magnitude” that was predicted by the machine learning model as being relevant to the query. The system transmits the query results to a client to present the query results together in the GUI 400c.

### 7. Practical Applications, Advantages, and Improvements

One or more embodiments provide a technical improvement over prior database access system by improving the searchability of a visualized set of query results by selecting, in real time, attributes for displaying in the query results. A conventional system may execute a query, return a set of query results, and present a default set of values for attributes in the query results. The default may be a hard-coded set of attributes or a set of attributes selected based on space available in a GUI for presenting attributes. One or more embodiments described herein improve the searchability of the visualized set of query results by predicting relevant attributes based on query information. Upon executing a query, the system may apply query information including terms, filters, and results information to a machine learning model. The model is trained to predict attributes relevant to queries. In some cases, the predicted attributes are not included among the attributes associated with database records returned by a query. In other words, the universe of attributes available to the machine learning model for predicting relevant attributes is greater than the subset of attributes included in retrieved database records. A database system selects a subset of attributes to include in a query response based on determining one or more attributes are relevant to query information even when the attributes are not specified by a query or query filter. Since the system predicts relevant attributes and presents the relevant attributes in response to the query, users and applications requesting queries are less likely to initiate subsequent queries to request additional records and attribute values.

One or more embodiments improve the execution of queries and the transmission of query results to a requesting client computer by extracting attribute values not specified by query terms and predicted to be relevant to the query results. In cloud environments and environments where multiple users and applications access the same database, conflicts arise when multiple requests arrive at a database server at the same time. High volumes of requests result in processing delays, increased wear on computing components, including processors, and increase heat generation of computing components, particularly for processing intensive operations. Inefficient query execution to the database results in the receipt of higher volumes of query requests, higher volumes of database queries, higher usage rates of processors, increased bandwidth utilization, and increased delays in processing requests. Predicting relevant attributes not specified in queries improves the functioning of a data management platform, including a database server. Since the system anticipates attributes that are relevant, but not specified, users and applications generate fewer database requests, reducing bandwidth utilization, processing usage rates, database access requests, and processing delays.

### 8. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 9. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

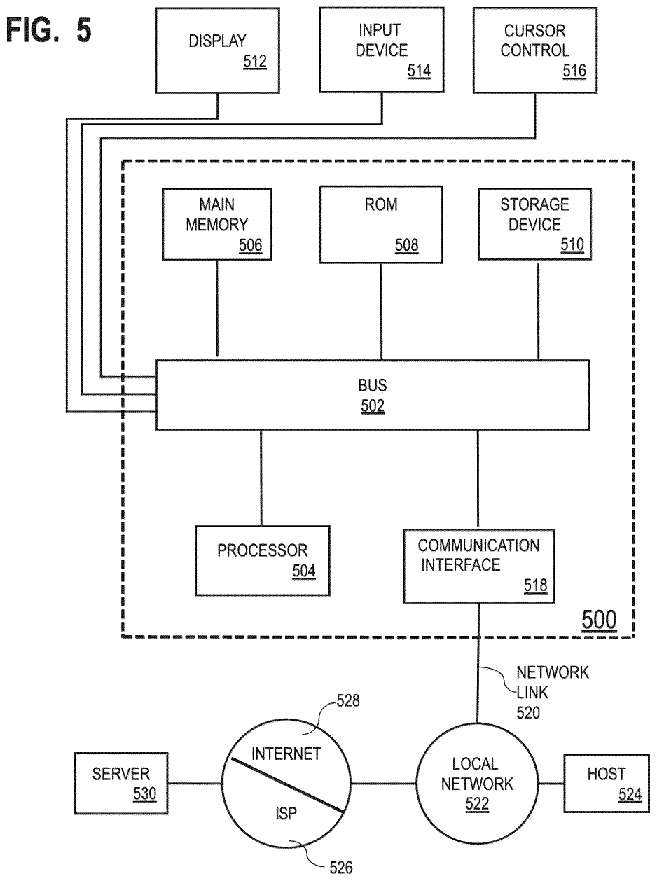

For example, FIG. 5 is a block diagram that illustrates a computer system 500 upon which an embodiment of the disclosure may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read-only memory (ROM) 508 or other static storage device coupled to bus 502 for storing static information and instructions for processor 504. A storage device 510, such as a magnetic disk, optical disk, or a Solid State Drive (SSD) is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### 10. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method comprising:
receiving, by a query execution engine, a first query including a first set of query terms;
executing, by the query execution engine, the first query on a database to identify a plurality of entities;
selecting a first attribute associated with one or more first attribute values to present with a first entity of the plurality of entities in response to the first query at least by:
determining, in real-time by the query execution engine, a first correlation between the first attribute and the first query, wherein the first attribute is not explicitly specified by the first query;
based on determining the first correlation, extracting the one or more first attribute values associated with the first attribute from a target entity, wherein the target entity is one of the first entity and a second entity; and
presenting the one or more first attribute values with the first entity in a set of search results in response to the first query,
wherein the method is performed by at least one device including a hardware processor.

2. The method of claim 1, wherein the first attribute is selected subsequent to identifying the plurality of entities.

3. The method of claim 1, wherein the first attribute is selected from a first plurality of attributes associated with the first entity, and wherein the method further comprises:
selecting at least a second attribute associated with a second entity of the plurality of entities based on a second correlation between the second attribute and the first query,
wherein the second attribute is different from the first attribute; and
displaying one or more second values corresponding to the second attribute with the second entity.

4. The method of claim 1, wherein selecting the first attribute comprises:
determining an entity type associated with the first entity; and
selecting the first attribute based on the entity type.

5. The method of claim 1, wherein selecting the first attribute comprises:
determining a time value corresponding to receipt of the first query; and
selecting the first attribute based on the time value.

6. The method of claim 1, wherein selecting the first attribute comprises:
determining a first location associated with the first entity;
determining a distance value corresponding to a distance between the first location and a second location associated with the first query; and
selecting the first attribute based on the distance value.

7. The method of claim 1, wherein the first query is received from a first computing device in communication with the query execution engine running on a database server,
wherein the query execution engine queries the database in response to receiving the first query from the first computing device, and
wherein the method further comprises:
transmitting, to the first computing device by the query execution engine, a query response identifying a set of records including a first record associated with the first entity and a first set of attribute values including a first attribute value for the first attribute.

8. The method of claim 1, wherein determining the first correlation between the first entity and the first attribute comprises determining the first correlation between one or more of the first set of query terms and the first attribute.

9. The method of claim 1, wherein determining the first correlation between the first entity and the first attribute comprises determining the first correlation between (a) a selected filter for filtering the plurality of entities and (b) the first attribute, wherein the first attribute is not explicitly specified by selected filter.

10. The method of claim 1, wherein determining the first correlation between the first entity and the first attribute comprises:
determining, in real-time by the query execution engine, a second correlation between a plurality of attributes and the first query;
ranking the plurality of attributes according to a relevance of the plurality of attributes to the first query; and
selecting the first attribute based on the ranking.

11. The method of claim 1, wherein determining the first correlation between the first entity and the first attribute comprises:
applying a set of input data including at least information describing the plurality of entities to a machine learning model trained to predict a relevance of attributes to queries;
receiving from the machine learning model a prediction specifying the first attribute; and
selecting the first attribute based on the prediction.

12. The method of claim 1, further comprising:
identifying, by the query execution engine, a first plurality of attributes included in a first set of database records associated with the plurality of entities;
determining, by the query execution engine, that the first attribute that is not among the first plurality of attributes;
generating, by the query execution engine, a second query on the database based on a second set of query terms to identify at least the second entity, wherein the second entity is not among the plurality of entities identified based on executing the first query on the database; and
extracting the one or more first attribute values from the second entity.

13. The method of claim 12, further comprising:
executing the second query subsequent to selecting the first attribute.

14. One or more non-transitory computer-readable media comprising instructions that, when executed by one or more hardware processors, cause performance of operations comprising:
receiving, by a query execution engine, a first query including a first set of query terms;
executing, by the query execution engine, the first query on a database to identify a plurality of entities;
selecting a first attribute associated with one or more first attribute values to present with a first entity of the plurality of entities in response to the first query at least by:
determining, in real-time by the query execution engine, a first correlation between the first attribute and the first query, wherein the first attribute is not explicitly specified by the first query;
based on determining the first correlation, extracting the one or more first attribute values associated with the first attribute from a target entity, wherein the target entity is one of the first entity and a second entity; and
presenting the one or more first attribute values with the first entity in a set of search results in response to the first query.

15. The non-transitory computer-readable media of claim 14, wherein the first attribute is selected subsequent to identifying the plurality of entities.

16. The non-transitory computer-readable media of claim 14, wherein the first attribute is selected from a first plurality of attributes associated with the first entity, and wherein the operations further comprise:
selecting at least a second attribute associated with a second entity of the plurality of entities based on a second correlation between the second attribute and the first query,
wherein the second attribute is different from the first attribute; and
displaying one or more second values corresponding to the second attribute with the second entity.

17. The non-transitory computer-readable media of claim 14, wherein selecting the first attribute comprises:
determining an entity type associated with the first entity; and
selecting the first attribute based on the entity type.

18. The non-transitory computer-readable media of claim 14, wherein determining the first correlation between the first entity and the first attribute comprises:
determining, in real-time by the query execution engine, a second correlation between a plurality of attributes and the first query;
ranking the plurality of attributes according to a relevance of the plurality of attributes to the first query; and
selecting the first attribute based on the ranking.

19. The non-transitory computer-readable media of claim 14, wherein determining the first correlation between the first entity and the first attribute comprises:
applying a set of input data including at least information describing the plurality of entities to a machine learning model trained to predict a relevance of attributes to queries;
receiving from the machine learning model a ranking of a plurality of attributes based on a predicted relevance of the plurality of attributes to the first query; and
selecting the first attribute based on the ranking.

20. A system comprising:
one or more hardware processors;
one or more non-transitory computer-readable media; and
program instructions stored on the one or more non-transitory computer-readable media which, when executed by the one or more hardware processors, cause the system to perform operations comprising:
receiving, by a query execution engine, a first query including a first set of query terms;
executing, by the query execution engine, the first query on a database to identify a plurality of entities;
selecting a first attribute associated with one or more first attribute values to present with a first entity of the plurality of entities in response to the first query at least by:
determining, in real-time by the query execution engine, a first correlation between the first attribute and the first query, wherein the first attribute is not explicitly specified by the first query;
based on determining the first correlation, extracting the one or more first attribute values associated with the first attribute from a target entity, wherein the target entity is one of the first entity and a second entity; and
presenting the one or more first attribute values with the first entity in a set of search results in response to the first query.
